(19) United States
(12) Patent Application Publication
(10) Pub. No.: US 2022/0383030 A1
(43) Pub. Date: Dec. 1, 2022

(54) Using few shot learning on recognition system for character image in industrial processes

(71) Applicant: 3DFAMILY TECHNOLOGY CO.,LTD., New Taipei City (TW)

(72) Inventors: Ta Wei TANG, New Taipei City (TW); Guan Deng WANG, New Taipei City (TW); Chih Chin HSU, New Taipei City (TW); Chao Chang LIAO, New Taipei City (TW)

(73) Assignee: 3DFAMILY TECHNOLOGY CO.,LTD., New Taipei City (TW)

(21) Appl. No.: 17/329,218

(22) Filed: May 25, 2021

(51) Int. Cl. G06K 9/20; G06N 3/04; G06K 9/62

(52) U.S. Cl. CPC G06K 9/2054; G06N 3/0454; G06K 9/627; G06K 2209/01

(57) ABSTRACT

An artificial intelligence optical character image recognition system and method, using few shot learning on recognition system for character image in industrial processes, mainly including: preparing two or more identical neural network architecture units, inputting similar or different character images respectively, and comparing the calculation results to see if the weights are similar. If the similarity reaches the set standard value, they are classified as the same type of character, otherwise different. Through such procedures, training samples in the storage unit are gradually divided into settings of character sets with different contextual meanings, becoming a complete AI OCR system. It can increase training sample data by comparing characters, without increasing the training set. Simultaneously, it can improve the flexibility of recognizing test characters.

### FIELD OF INVENTION

This invention is an artificial intelligence method that uses method of few shot learning. It is used as a tool to identify character images in industrial processes, breaking through the traditional automatic optical image detection, the use of artificial intelligence requires the collection of a large number of samples.

### BACKGROUND

The commonly called AI is actually the abbreviation of Artificial Intelligence, and this name also clearly expresses its meaning. The definition of AI is actually a computer program written by “artificial” to simulate human “intelligence” behavior. Including the “listening and reading, visual recognition” that simulates the human senses, the “reasoning and decision-making, understanding and learning” of the human brain, and the “movement and motion control” of human actions.

In traditional programming, engineers turn their ideas and business into codes, and the computer will run according to the logic set by the codes. In recent years, the deep learning technology through the design of neural network allows the model to automatically adjust the best parameters during the learning process, in order to break through the problem of low adaptability due to sequential logic, greatly improving the scope and ability of the computer to solve problems.

A Taiwanese patent titled “a character recognition method and system” (Announcement No. TW 215953) mainly processes character image to different degrees. First, the image is processed through binarized noise reduction, blurring the background, which is more conducive to separate the character from the background. Then correction and alignment methods are used to make the character upright. Next, the characters are separated from the background, and the separated characters outline are mapped to the preset character template in the machine. If it matches the template, the characters are converted to the internal code that is displayed correspondingly with the computer, and then the characters are saved in digital form. However, this patent TW 215953 is more suitable for processing printed characters. If encountering handwritten characters or newly created fonts, the outline of the selected characters will be difficult to correspond to the old template, greatly reducing the character recognition rate. Also, when the character background is messy or the background material is different, the difficulty of character cutting will be greatly increased. Therefore, the method used in the past is more suitable for the word processing system, and it is difficult to use the code detection on the industrial parts of different sizes and materials.

As a result, a U.S. Pat. No. 10,489,671 B2 titled “LOCATION BASED OPTICAL CHARACTER RECOGNITION (OCR)”, proposed that one of the known main methods in industrial inspection and document processing is by combining optical inspection systems with the CNN algorithm of in AI, to input a large amount of character image for detection into the AI training model. Then the AI algorithm establishes a suitable classification curve model, applies the character image to be detected, and maps the image to a suitable classification set. However, this method has very detailed requirements for recognizing the font shape, font size, light source, and font background of the character. Also, the technical content of the patent U.S. Pat. No. 10,489,671 B2, requires a large amount of character image of various forms to be added to the training set to reduce the decline in accuracy of character recognition, if there are defects in the text imaging that do not affect the recognition by the human eye, including dirt, disconnection, or stroke position offset. The expansion of the training set means more manpower and time investment, which in turn increases the time and cost of training on the character recognition system.

At the same time, the current application of AI for character recognition requires a large amount of data to be collected as training samples. When the amount of training data is insufficient or the training data is not diverse enough, it will be necessary to use the few shot learning technique. Besides, as for the AI model of character recognition, few shot learning is closer to the scene of human learning. Simultaneously, large samples of data require enormous labor costs for labeling. Therefore, the inventor of this case, in view of that the ones with deficiencies of acquired skills is in urgent need of a new AI character image recognition technology suitable for industrial use, after years of painstaking research and development, proposed the present invention, using few shot learning on recognition system for character image in industrial processes, achieved by applying small sample data.

### SUMMARY

The present invention, using few shot learning on recognition system for character image in industrial processes, operates in the following steps: using the control unit to intercept the range of each character image to be classified, and inputting the signal to two or more sets of identical neural network architecture unit prepared, with each group of neural network architecture having the same weight parameter, then matching with the control unit, inputting similar or different character image into the two or more sets of identical neural network architecture units, so that they perform deep calculations. After the result is calculated, the result signal is input into the comparing unit to confirm whether the weights of the comparison operation results are similar. If the similarity is as high as the standard value set in the comparing unit, a signal will be output into the storage unit and the character will be classified as the same type of characters; otherwise a signal will be output into the storage unit and the character will be classified as a different type of characters. Through this method, the training samples in the storage unit are gradually divided into settings of character sets with different contextual meanings.

As shown above, the image device mainly includes: one control unit, connecting to two or more sets of identical neural network architecture units respectively, can intercept each character image range to be classified; two or more sets of identical neural network architecture unit, with each group of neural network architecture having the same weight parameter, able to receive similar or different characters image input from the control unit, perform in-depth calculations with result signals being output into the comparing unit; one comparing unit, receiving signals from two or more sets of identical neural network architecture unit after deep calculation, to confirm whether the weights of the comparison operation results are similar, then outputting the signals into the storage unit; one storage unit, receiving the signals output from the comparing unit after the comparing process is finished. If the similarity is as high as the standard value set in the comparing unit, a signal will be output into the storage unit and the character will be classified as the same type of characters, otherwise a signal will be output into the storage unit and the character will be classified as different types of characters. In this way, the training samples in the storage unit are gradually divided into settings of character sets with different contextual meanings.

### DESCRIPTION OF DRAWINGS

FIG. 1 is a block diagram of the present invention.

FIG. 2 is the main flow chart of the method of the present invention.

### DETAILED DESCRIPTION OF INVENTION

The main purpose of the present invention, using few shot learning on recognition system for character image in industrial processes, is to improve the accuracy of judgments by detecting character codes on materials of different sizes in the industry, offering the actual value for industrial testing and document use, so it has a wider range of applicability.

Another purpose of the present invention, using few shot learning on recognition system for character image in industrial processes, is that, apart from the actual value for industrial detection and document use, if it is necessary to increase the text classification set, it is also easy to continue training from the existing models, thus reducing the complete effect requirements required by the advantage of the cost of maintaining the character recognition system.

In order to achieve the above and other objectives, the present invention, using few shot learning on recognition system for character image in industrial processes, is suitable for industrial character code detection on different materials and of different sizes.

The implementation method of the present invention, using few shot learning on recognition system for character image in industrial processes, is to first intercept each character's image range, and then prepare two or more sets of identical neural network architecture unit, with the same weight parameters of each group of neural network architecture units. Next, input similar or different character image respectively. After the calculation, the comparing unit compares whether the calculation result weights are similar. If the similarity is as high as the standard value set in the comparing unit, the character image will be output into the storage unit and classified as the same type of characters; otherwise, it will be output into the storage unit and classified as a different type of characters. Through this method, the training samples in the storage unit are gradually divided into settings of character sets with different contextual meanings.

Therefore, the present invention, using few shot learning on recognition system for character image in industrial processes, is a complete AI character image recognition system and method developed from the method of comparing whether the weights of the calculation results are similar. If the similarity is as high as the set standard value, it will be classified as the same type of characters, otherwise different. Through this method, the training samples in the storage unit are gradually divided into settings of character sets with different contextual meanings. For character detection, without increasing the training set, the training sample data can be increased through comparison at first, and the flexibility in recognizing test characters can be increased simultaneously. One set of training model can correspond to different fonts and different handwriting samples, while the requirements for text background are also reduced at the same time. The model can compare text features by itself in the process of feature extraction, and exclude background features, so as to improve the practical industrial detection requirements and the accuracy of judgments, improving the accuracy of character code recognition, thus reducing the cost of industrial applications. In addition, if it is necessary to increase the character classification set, it can also be easily modified from the existing model, which reduces the cost of maintaining the character recognition system and enhances the actual value advantage of industrial testing and document use.

### Embodiment

The following is the embodiment of combining specific objective examples with the present invention. Those familiar with the art can easily understand the other advantages and effects of the present invention from the content disclosed in this specification. The present invention can also be implemented or applied through other different specific examples. Based on different viewpoints and applications, various details in this patent specification can also be modified and changed in various ways without departing from the spirit of the present invention.

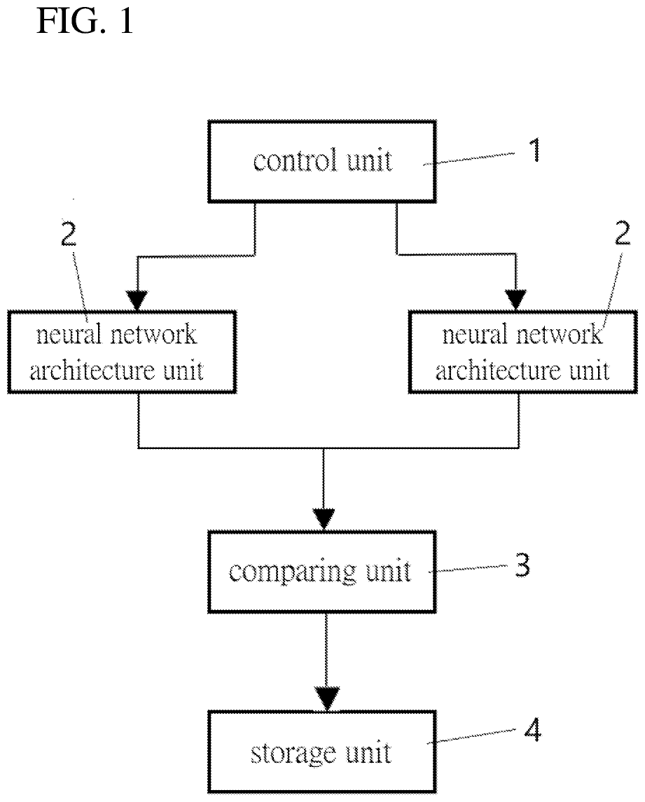

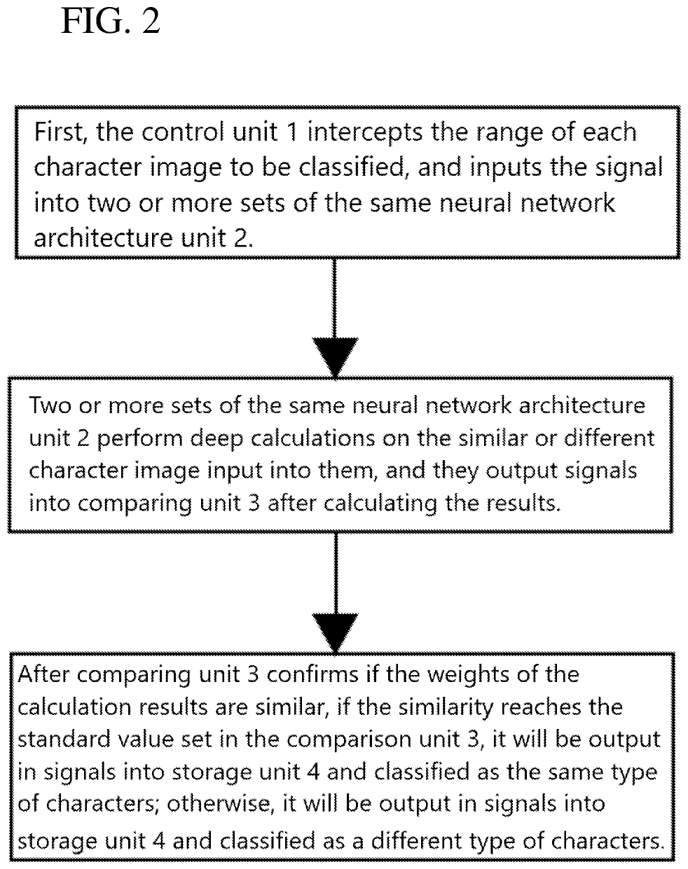

First of all, please refer to FIGS. 1 and 2 with the remaining images. The present invention, using few shot learning on recognition system for character image in industrial processes, mainly relates to: First, the control unit 1 intercepts the range of each character image to be classified, and it inputs the signal into two or more sets of identical neural network architecture unit 2. Each group of neural network architecture has the same weight parameter. Then, it is matched with the control unit 1 to input similar or different character image into the two or more sets of identical neural network architecture units 2, so that the two or more sets of identical neural network architecture units 2 performs deep calculations. After the result is calculated, the input signal is used in the comparing unit 3 to confirm whether the weights of the comparing operation results are similar. If the similarity is as high as the standard value set in the comparing unit 3, the result signal will be output into the storage unit 4 and classified as the same type of characters; otherwise the result signal will be output to the storage unit 4 and be classified as a different type of characters. Through this method, the training samples in the storage unit 4 are gradually divided into settings of character sets with different contextual meanings.

Please further refer to FIG. 1 and FIG. 2 with the remaining images. The present invention, using few shot learning on recognition system for character image in industrial processes, is based on the concept of this method. This AI character image recognition system mainly includes: Control unit 1, connected to two or more sets of identical neural network architecture units 2 respectively, can intercept each character image range to be classified.

Two or more sets of identical neural network architecture unit 2. Each group of neural network has the same weight parameter, and receives similar or different character image input by the control unit 1 with the signals jointed, so that these two or more sets of identical neural network architecture unit 2 perform in-depth calculations. After calculating the results, the signals will be output and jointed into the comparing unit 3.

Comparing unit 3, jointed from receiving the signals of two or more sets of identical neural network architecture unit 2 after deep calculation, to confirm whether the weights of the comparison calculation results are similar, and outputting the signals and jointed into the storage unit 4.

The storage unit 4, jointed from receives the signal output, after the comparing unit 3 finished comparing. If the similarity is as high as the standard value set in the comparing unit 3, the signal is output into the storage unit 4 and classified as the same type of characters, otherwise the signal is output into the storage unit 4 and classified as a different type of characters. In this way, the training samples in the storage unit 4 are gradually divided into settings of character sets with different contextual meanings.

Please further refer to FIG. 1 and FIG. 2 with the remaining images. The present invention, using few shot learning on recognition system for character image in industrial processes, is a complete AI character image recognition system and method developed from the method of comparing whether the weights of the calculation results are similar. If the similarity is as high as the set standard value, it will be classified as the same type of characters, otherwise different. Through this method, the training samples in the storage unit are gradually divided into settings of character sets with different contextual meanings. For character detection, without increasing the training set, the training sample data can be increased through comparison at first, and the flexibility in recognizing test characters can be increased simultaneously. One set of training model can correspond to different fonts and different handwriting samples, while the requirements for text background are also reduced at the same time. The model can compare text features by itself in the process of feature extraction, and exclude background features, so as to improve the practical industrial detection requirements and the accuracy of judgments, improving the accuracy of character code recognition, thus reducing the cost of industrial applications. In addition, if it is necessary to increase the character classification set, it can also be easily modified from the existing model, which reduces the cost of maintaining the character recognition system, having the advantage of enhancing the actual value of industrial testing and document use to meet the need for effects in use, thus becoming the effective creative factor of the present invention.

1. Using few shot learning on recognition system for character image in industrial processes, mainly relating to:
First, using the control unit to cut out the range of each character image to be classified, and inputting the signal to two or more sets of the same neural network architecture unit prepared, with each group of neural network architecture having the same weight parameter, then matching with the control unit to input similar or different character images into the two or more sets of identical neural network architecture units, so the two or more sets of identical neural network architecture units performing deep calculations; After the result being calculated, the input signal being used in the comparing unit to confirm whether the weights of the comparison operation results are similar, if the similarity reaching the standard value set in the comparing unit, the signal being output to the storage unit and classified as the same type of characters; otherwise the signal being output to the storage unit and classified as a different type of characters; Through this method, the training samples in the storage unit 4 gradually being divided into the settings of different contextual character sets.

2. As shown in the AI artificial intelligence text image recognition system and method in claim 1, the image capturing device mainly including:
The control unit, connecting to two or more sets of identical neural network architecture units respectively, can cut out each character image range to be classified;
Two or more sets of identical neural network architecture unit, with each group of neural network having the same weight parameter, able to receive similar or different character image input by the control unit with the signals connected, perform in-depth calculations with result signals being output, connected, and input to the comparing unit;
Comparing unit, receiving the signals of two or more sets of identical neural network architecture unit after deep calculation, to confirm whether the weights of the comparison calculation results are similar, and outputting the signals into the storage unit;
The storage unit, receiving the signal output, after the comparing unit finishing comparing. If the similarity is as high as the standard value set in the comparing unit, the signal is output into the storage unit and classified as the same type of characters, otherwise the signal is output into the storage unit and classified as different types of text. In this way, the training samples in the storage unit are gradually divided into the settings of different textual text sets.
